(19) United States
(12) Patent Application Publication
(10) Pub. No.: US 2026/0357164 A1
(43) Pub. Date: Nov. 12, 2026

(54) HEAT STABLE CLEANSING COMPOSITIONS AND METHODS OF FORMING

(71) Applicant: ELC Management LLC, Melville, NY (US)

(72) Inventors: Wei Chen, Syosset, NY (US); Shah SNEHAL, Nesconset, NY (US); James J. LYONS, Holtsville, NY (US); Victoria Quinn BRADY, West Babylon, NY (US); Elena Liliana SAVA, Hewlett, NY (US)

(21) Appl. No.: 19/203,061

(22) Filed: May 8, 2025

(51) Int. Cl. C11D 10/04; C11D 1/825; C11D 3/04; C11D 9/00; C11D 9/26

(52) U.S. Cl. CPC C11D 10/045; C11D 1/825; C11D 3/044; C11D 9/007; C11D 9/267

(57) ABSTRACT

Cleansing compositions including a fatty acid soap material, at least one fatty alcohol, and water are described. The at least one fatty alcohol may be present in an amount of at least about 3% by weight (wt %) based on a total weight of the cleansing composition. The at least one fatty alcohol may include cetyl alcohol, stearyl alcohol, cetearyl alcohol, or any mixture thereof. The cleansing compositions may remain stable after exposure to (e.g., storage in, transport in, etc.) elevated temperatures, such as, for example, temperatures up to about 50 °C. Related methods of forming cleansing compositions are also described.

### FIELD OF THE INVENTION

The disclosure, in various embodiments, relates generally to the field of cleansing compositions. More particularly, the disclosure relates to gel or liquid soap-based cleansing compositions comprising a fatty alcohol.

### BACKGROUND

Liquid and gel soaps are widely used in personal care and household cleaning applications due to their convenience, ease of use, and ability to effectively remove dirt and oils from the skin and various surfaces. However, maintaining the stability of liquid and gel soaps, particularly when exposed to elevated temperatures, remains a significant challenge.

Liquid and gel soaps are typically formulated with surfactants (e.g., soaps), water, and various functional additives, such as, for example, thickeners, moisturizers, fragrances, and preservatives. At elevated temperatures (e.g., above about 40 °C), these soaps may undergo undesirable physical and chemical changes that compromise performance, physical appearance, and shelf life. For example, exposure to elevated temperatures may lead to phase separation, viscosity loss, or precipitation of ingredients, resulting in a non-homogenous composition, reduced foaming properties, and an unsatisfactory consumer experience. Additionally, instability at high temperatures may cause degradation of active ingredients, leading to diminished efficacy and potential safety concerns. In extreme cases, instability can lead to packaging issues, such as leaking, gelling, or separation within a dispensing mechanism, making the soap difficult for a consumer to use.

Based on the foregoing, there is a need for improved liquid and gel soap compositions that can withstand exposure to elevated temperatures without compromising their stability, physical appearance, or performance.

### BRIEF SUMMARY

Cleansing compositions including a fatty acid soap material, at least one fatty alcohol, and water are disclosed herein. The at least one fatty alcohol may be present in an amount of at least about 3% by weight (wt %) based on a total weight of the cleansing composition. The at least one fatty alcohol may include cetyl alcohol, stearyl alcohol, cetearyl alcohol, or any mixture thereof.

Methods of forming cleansing compositions are disclosed herein. The methods may include combining one or more fatty acids to form a fatty acid mixture, melting the fatty acid mixture, incorporating at least one fatty alcohol into the fatty acid mixture, and neutralizing at least a portion of the one or more fatty acids by reacting the one or more fatty acids with at least one base to form at least one fatty acid soap. The at least one fatty alcohol may be incorporated at an amount of at least about 3 wt % based on a total weight of the resulting cleansing composition. The at least one fatty alcohol may include cetyl alcohol, stearyl alcohol, cetearyl alcohol, or any mixture thereof.

### DETAILED DESCRIPTION

The following description provides specific details, such as material types and process conditions, in order to provide a thorough description of embodiments described herein. However, a person of ordinary skill in the art will understand that the embodiments disclosed herein may be practiced without employing these specific details. Indeed, the embodiments disclosed herein may be practiced in conjunction with conventional formulation techniques employed in the cleansing composition and/or cosmetic formulation industry. In addition, the description provided herein does not form a complete description of a cleansing composition or a complete process flow for manufacturing a cleansing composition. Only those elements, ingredients, and acts necessary to understand the embodiments described herein are described in detail below. Additional cosmetically acceptable ingredients may be included to form a complete cleansing composition without departing from the scope of this disclosure. Furthermore, additional acts to form a complete cleansing composition may be performed using conventional techniques without departing from the scope of this disclosure.

As used herein, the singular forms “a,” “an,” and “the” are intended to include the plural forms as well, unless the context clearly indicates otherwise.

As used herein, “and/or” includes any and all combinations of one or more of the associated listed items.

As used herein, “at least one” means and includes one or more (e.g., two, three, multiple, any amount greater than or equal to one).

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0% to 110.0% of the numerical value, such as within a range of from 95.0% to 105.0% of the numerical value, within a range of from 97.5% to 102.5% of the numerical value, within a range of from 99.0% to 101.0% of the numerical value, within a range of from 99.5% to 100.5% of the numerical value, or within a range of from 99.9% to 100.1% of the numerical value.

The dimensions, amounts, and values disclosed herein are not to be understood as being strictly limited to the exact numerical values recited. Instead, unless otherwise specified, each such dimension, amount, and value is intended to mean both the recited value and a functionally equivalent range surrounding that value. For example, an amount disclosed as “35% by weight” is intended to mean “about 35% by weight.”

As used herein, the term “substantially” in reference to a given parameter, property, or condition means and includes to a degree that one of ordinary skill in the art would understand that the given parameter, property, or condition is met with a degree of variance, such as acceptable tolerances. By way of example, depending on the particular parameter, property, or condition that is substantially met, the parameter, property, or condition may be at least 90.0% met, at least 95.0% met, at least 99.0% met, at least 99.9% met, or even 100.0% met.

As used herein, the term “cosmetically acceptable” means that the given composition, formulation, or component is generally suitable for use in contact with human keratinous tissue (e.g., skin, hair) without undue toxicity, incompatibility, instability, allergic response, hazardous reaction, and the like.

As used herein, the terms “soap” and “fatty acid soap” mean and include a salt of a fatty acid formed by reacting a fatty acid with a base, such as, for example, sodium or potassium hydroxide. The fatty acid may be saturated or unsaturated. The salt of a fatty acid preferably includes at least 8 carbon atoms to provide desirable surfactant properties. The terms “soap” and “fatty acid soap” include a single salt of a fatty acid and/or a mixture of two or more fatty acid salts.

Cleansing compositions according to the disclosure include a fatty acid soap material, at least one fatty alcohol, and water. The at least one fatty alcohol preferably includes cetearyl alcohol, stearyl alcohol, cetyl alcohol, or any combination thereof. The cleansing compositions are preferably in the form of a liquid or a gel. The cleansing compositions are preferably substantially homogeneous. The at least one fatty alcohol may advantageously promote formation of a stable gel network within the cleansing compositions, improving thermal stability and preventing phase separation, thereby extending a shelf life and maintaining a desired texture, color, and effectiveness of the cleansing compositions. The cleansing compositions may remain stable after exposure to elevated temperatures, such as, for example, exposure to any temperature up to about 50 °C. The improved stability and reduced or prevented phase separation of the cleansing compositions may improve a consumer's experience during and/or after use (e.g., application) of the cleansing compositions, by promoting a smooth and uniform texture, maintaining desired flow characteristics (e.g., viscosity), and ensuring a homogeneous distribution of surfactants (e.g., cleansers, soaps) within the cleansing compositions.

The cleansing compositions disclosed herein include a fatty acid soap material. The fatty acid soap material may include at least one fatty acid soap (e.g., one or more fatty acid soaps) and at least one unneutralized fatty acid (e.g., free fatty acid). The at least one fatty acid soap is preferably a primary surfactant component of the cleansing compositions. The at least one fatty acid soap may be formed by reacting (e.g., neutralizing) one or more fatty acids (e.g., free fatty acids) with at least one base.

The one or more fatty acids may be saturated or unsaturated. The fatty acids may include aliphatic alkane- or alkene-monocarboxylic fatty acids, preferably having 6 to 22 carbon atoms, more preferably having 8 to 18 carbon atoms. Suitable fatty acids include, but are not limited to, stearic acid, myristic acid, lauric acid, palmitic acid, oleic acid, linoleic acid, ricinoleic acid, linolenic acid, capric acid, caprylic acid, behenic acid, isostearic acid, erucic acid, pelargonic acid, arachidic acid, and combinations thereof. The one or more fatty acids preferably include myristic acid, lauric acid, behenic acid, stearic acid, palmitic acid, or any combination thereof. A ny and all cosmetically acceptable fatty acids typical in the art of soap and/or cleanser formulation are considered to be suitable. The fatty acids may be liquid or solid at room temperature (e.g., within a range of from about 20 °C to about 25 °C). Preferably, the one or more fatty acids exhibit an overall (e.g., combined) melting point of less than or substantially equal to about 80 °C. In some embodiments, the one or more fatty acids each exhibit an overall melting point within a range of from about 40 °C to about 80 °C.

In some embodiments, the one or more fatty acids may be formed (e.g., generated) by hydrolysis (e.g., enzymatic hydrolysis, direct base-catalyzed hydrolysis) of one or more fatty acid sources. Suitable fatty acid sources include, but are not limited to, vegetable oils, such as coconut oil, palm oil, olive oil, avocado oil, sunflower oil, soybean oil, castor oil, and canola oil, animal fats, such as tallow, lard, and fish oil, algal oils, single-cell oils from yeast or fungi, hydrogenated vegetable oils, and fractionated oils. Hydrolysis of the one or more fatty acid sources may form (e.g., generate, release) the one or more free fatty acids and glycerol.

By way of non-limiting example, the at least one base may include metal hydroxides (e.g., sodium hydroxide (NaOH), potassium hydroxide (KOH)), organic amines (e.g., mono-, di-, tri-ethanol amine, ammonium hydroxide), carbonate-based bases (e.g., potassium carbonate, sodium carbonate), or any combination thereof. The at least one base preferably includes KOH. The base may be in any suitable form, such as, for example, a powder or a solution (e.g., a caustic neutralizing solution). In some embodiments, the at least one base is a caustic neutralizing solution comprising KOH. Any and all cosmetically acceptable bases typical in the art of soap and/or cleanser formulation are considered to be suitable.

The fatty acid soap material disclosed herein may include a mixture of one or more neutralized fatty acids (e.g., fatty acid soaps) and one or more free fatty acids (e.g., unreacted fatty acids, unneutralized fatty acids). The fatty acid soap material preferably includes the neutralized fatty acids (e.g., fatty acid soaps) in an amount within a range of from about 10% by mole (mol %) to about 90 mol %, such as, for example, within a range of from about 10 mol % to about 50 mol %, from about 10 mol % to about 80 mol %, from about 20 mol % to about 40 mol %, from about 20 mol % to about 90 mol %, from about 30 mol % to about 60 mol %, from about 40 mol % to about 80 mol %, from about 60 mol % to about 80 mol %, from about 65 mol % to about 85 mol %, from about 70 mol % to about 85 mol %, or from about 70 mol % to about 80 mol % based on an initial amount of the one or more fatty acids. The fatty acid soap material preferably includes the neutralized fatty acids in an amount within a range of from about 10 mol % to about 80 mol %, and more preferably within a range of from about 60 mol % to about 80 mol %.

The cleansing compositions may include the fatty acid soap material in an amount within a range of from about 10 wt % to about 80 wt % based on a total weight of the cleansing composition, such as, for example, within a range of from about 10 wt % to about 30 wt %, from about 30 wt % to about 50 wt %, or from about 50 wt % to about 80 wt % based on the total weight of the cleansing composition. The cleansing composition preferably includes the fatty acid soap material in an amount within a range of from about 30 wt % to about 50 wt % based on a total weight of the cleansing composition.

The cleansing compositions may include a solvent comprising water. The cleansing compositions may include the solvent at an amount within a range of from about 20 wt % to about 90 wt % based on a total weight of the cleansing composition, such as, for example, within a range of from about 20 wt % to about 40 wt %, from about 30 wt % to about 50 wt %, from about 30 wt % to about 60 wt %, from about 40 wt % to about 70 wt %, from about 50 wt % to about 90 wt %, or from about 70 wt % to about 90 wt % based on the total weight of the cleansing composition. The cleansing compositions preferably include the solvent in an amount within a range of from about 30 wt % to about 50 wt %. The solvent may further comprise caustic neutralizing solution and/or non-water co-solvent (e.g., propylene glycol, dipropylene glycol, polypropylene glycol, glycerin, hexylene glycol). In some embodiments, the solvent consists of water. In some embodiments, the solvent includes water and glycerin.

The cleansing compositions disclosed herein include at least one fatty alcohol. The fatty alcohol may include one or more fatty alcohols having within a range of from 6 to 22 carbon atoms, such as, for example, within a range of from 6 to 10 carbon atoms, from 12 to 14 carbon atoms, from 16 to 22 carbon atoms, or from 16 to 18 carbon atoms. The fatty alcohol preferably includes cetyl alcohol (C₁₆H₃₄O), stearyl alcohol (C₁₈H₃₈O), cetearyl alcohol (e.g., cetyl stearyl alcohol) (C₁₆H₃₄O+C₁₈H₃₈O), or any combination thereof. The cetearyl alcohol may include cetyl alcohol and stearyl alcohol in any suitable molar ratio, such as, for example within a range of from about 2:1 to about 1:2 cetyl alcohol to stearyl alcohol. In some embodiments, the cetearyl alcohol includes cetyl alcohol and stearyl alcohol in a molar ratio of about 1:1. In some embodiments, the fatty alcohol consists of cetearyl alcohol. In some embodiments, the fatty alcohol consists of cetyl alcohol. In some embodiments, the fatty alcohol consists of stearyl alcohol.

Such fatty alcohols are commercially available from numerous sources including, but not limited to, Badische Anilin-& Sodafabrik (BASF) (Ludwigshafen, DE), Kao Chemicals Europe, S.L. (Barberà del Vallès, ES), Croda International (Yorkshire, UK), Surfachem (West Yorkshire, UK), and Sasol Chemicals LLC (Houston, TX). The at least one fatty alcohol may include, but is not limited to, Lanette® O (cetearyl alcohol), Lanette® 16 (cetyl alcohol), or Lanette® 18 (stearyl alcohol) from BASF, Kalcol® 6850 (cetearyl alcohol), Kalcol® 8670 (steryl-cetyl alcohol), Kalcol® 6098 (cetyl alcohol), or Kalcol® 8098 (stearyl alcohol) from Kao Chemicals Europe, S.L., Crodacol™ CS50 (cetearyl alcohol), Crodacol™ C₉₀ (cetyl alcohol), or Crodacol™ S95 (stearyl alcohol) from Croda International, SURFAC® CS (cetearyl alcohol), SURFAC® CS 50:50 M B (cetearyl alcohol), or SURFAC® Cetyl Alcohol MB (cetyl alcohol) from Surfachem, NACOL 16-98 (cetyl alcohol), NACOL 18-98 (stearyl alcohol), NA FOL 1618 (cetearyl alcohol), or ALFOL 1618 (cetearyl alcohol) from Sasol Chemicals LLC, or any combinations thereof.

The cleansing compositions disclosed herein preferably include the fatty alcohol in an amount of at least about 3 wt % based on a total weight of the cleansing composition, such as, for example, at least about 4 wt %, at least about 5 wt %, at least about 6 wt %, at least about 10 wt %, or at least about 15 wt % based on the total weight of the cleansing composition. The cleansing compositions may include the fatty alcohol in an amount within a range of from about 1 wt % to about 15 wt % based on a total weight of the cleansing composition, such as, for example, within a range of from about 1 wt % to about 5 wt %, from about 1 wt % to about 10 wt %, from about 3 wt % to about 4 wt %, from about 3 wt % to about 5 wt %, from about 3 wt % to about 6 wt %, from about 3 wt % to about 10 wt %, from about 3 wt % to about 15 wt %, from about 4 wt % to about 10 wt %, from about 5 wt % to about 10 wt %, or from about 10 wt % to about 15 wt % based on the total weight of the cleansing composition. The cleansing compositions preferably include the fatty alcohol in an amount within a range of from about 1 wt % to about 5 wt % based on the total weight of the cleansing composition. The cleansing compositions most preferably include the fatty alcohol in an amount within a range of from about 3 wt % to about 5 wt % based on the total weight of the cleansing composition.

Incorporating the at least one fatty alcohol at an amount of at least about 3 wt % based on a total weight of the cleansing composition surprisingly improves stability of the cleansing compositions at elevated temperatures by advantageously promoting the formation of a stable gel network within the cleansing compositions. Stability of cleansing compositions at elevated temperatures enables effective cleaning ability, uniform distribution of components (e.g., soap, solvent, active ingredients, colorants, fragrances, etc.), and good aesthetics for the cleansing compositions after exposure to, travel in, or storage in elevated temperatures. The cleansing compositions including the at least one fatty alcohol may remain stable at temperatures greater than or equal to about 40 °C. In some embodiments, the cleansing compositions including the at least one fatty alcohol remain stable up to a temperature within a range of from about 40 °C to about 55 °C, such as, for example, up to about 40 °C, up to about 45 °C, up to about 50 °C, or up to about 55 °C.

The cleansing compositions disclosed herein may include one or more additional cosmetically acceptable ingredients, such as, for example, sequestering agents, moisturizing agents, suds boosters, astringent agents, chelating agents, pH adjustors, active agents, self-tanning agents, film-formers (e.g., film producing polymers), thickening agents, gelling agents, odor absorbers, additional surfactants, surfactant alternatives (e.g., isoalkanes), emollients, preservatives, stabilizers, emulsifiers, antioxidants, antimicrobial agents, humectants, fragrances, essential fatty acids, essential oils, structuring agents, silicas, silicates, vitamins, colorants (e.g., pigments, dyes, mica), conditioning agents (e.g., cationic polymers, such as polyquarternium-7 and guar hydroxypropyltrimonium chloride), exfoliating agents, waxes, clays, glitter, shimmer, pearlizing agents, opacifiers, or any combinations thereof. The additional cosmetically acceptable ingredients may be water-soluble, water-insoluble, or a mixture thereof. Any and all cosmetically acceptable ingredients that may be incorporated into a liquid or gel composition are considered to be suitable. The above-described additional cosmetically acceptable ingredients are optional components of the cleansing compositions disclosed herein and may be omitted without materially affecting the cleansing compositions.

The compositions disclosed herein may further include one or more additional surfactants. Suitable surfactants include, but are not limited to, anionic surfactants, such as, for example, sodium methyl cocoyl taurate, sodium cocoyl isethionate, sodium lauryl sulfate, sodium laureth sulfate, sodium lauroyl sarcosinate, and sodium coco-sulfate, amphoteric surfactants, such as, for example, cocoamidopropyl betaine, coco betaine, lauryl betaine, and sodium cocoamphoacetate, and non-ionic surfactants, such as, for example, decyl glucoside, lauryl glucoside, caprylyl/capryl glucoside, and polysorbates. Any and all cosmetically acceptable surfactants are considered to be suitable. In some embodiments, the cleansing compositions are substantially free (e.g., include about 0 wt %) of polyethylene glycol (PEG). In some embodiments, the cleansing compositions are substantially free (e.g., include about 0 wt %) of sulfates.

The compositions disclosed herein may include one or more active agents. The one or more active agents may be any cosmetically acceptable active agents. Suitable active agents include, but are not limited to, moisturizing actives, agents used to treat age spots, keratoses, and wrinkles, anti-acne agents, antibacterial agents, anti-yeast agents, antifungal agents, antidandruff agents, anti-dermatitis agents, antipruritic agents, anti-irritant agents, anti-dry skin agents, anti-seborrheic agents, anti-aging agents, anti-wrinkle agents, antihistamine agents, skin lightening agents, depigmenting agents, would-healing agents, vitamins, and self-tanning agents.

The compositions disclosed herein may include one or more emollients. Suitable emollients include, but are not limited to, coconut oil and coconut oil derivatives, such as cocamide diethanolamide (DEA) and cocamide monoethanolamine (MEA), PEG-7 glyceryl cocoate, shea butter esters (e.g., PEG-100 stearate), and linear alkanes, such as C13-15 alkane and C15-19 alkane. Any and all cosmetically acceptable emollients are considered to be suitable.

The compositions disclosed herein may include preservatives to provide a prolonged shelf life. Suitable preservatives include, but are not limited to, potassium sorbate, imidazolidinyl urea, p-hydroxy benzoate, sodium benzoate, benzoyl alcohol, citric acid, esters of p-hydroxybenzoic acid, cosmetically acceptable parabens (e.g., methylparaben, propylparaben, butylparaben, ethylparaben, Personal Care Products Council (PCPC), previously the Cosmetic, Toiletry, and Fragrance Association (CTFA), designation parabens), ethylhexylglycerin, phenoxyethanol, caprylyl glycol, and hexylene glycol. Any and all cosmetically acceptable preservatives are considered to be suitable.

The compositions disclosed herein may optionally include a fragrance in any suitable amount, such as, for example, in an amount sufficient to make the composition more appealing to a consumer. Preferably, the compositions include the fragrance in an amount of from about 0.01 wt % to about 10 wt % based on a total weight of the cosmetic composition.

The compositions disclosed herein may include a pH adjustor in any suitable amount, such as, for example, in an amount sufficient to modify the pH of the cleansing to be within a range of from about 3 to about 11, preferably within a range of from about 6 to about 10, more preferably within a range of from about 8 to about 10.

Methods of forming cleansing compositions according to the disclosure may include forming a fatty acid mixture comprising the one or more fatty acids and the one or more fatty alcohols, followed by at least partial neutralization of the one or more fatty acids to form the at least one fatty acid soap. The fatty acid mixture may be formed by combining the one or more fatty acids and heating to an elevated temperature substantially equal to or greater than the overall melting point of the one or more fatty acids. Preferably, the one or more fatty acids are heated to a temperature of at least about 80 °C. The fatty acid mixture may be maintained at the elevated temperature for a period sufficient to melt any solid fatty acids, if present, forming a liquid. The one or more fatty acids may be stirred (e.g., mixed, agitated) before, during, and/or after heating. Accordingly, after heating, the fatty acid mixture may be a substantially homogeneous liquid. The one or more fatty alcohols may be incorporated into the fatty acid mixture before, during, and/or after heating the one or more fatty acids. Additional cosmetically acceptable ingredients, if present, may be added to the fatty acid mixture before, during, and/or after heating the one or more fatty acids.

A fter heating, at least a portion of the one or more fatty acids may be neutralized by reacting with the at least one base to form the at least one fatty soap. The at least one base may be provided in any suitable form, preferably as a caustic neutralizing solution including water and the at least one base. The at least one base preferably includes KOH. An amount of the at least one base to be added to the fatty acid mixture may be determined based on a desired degree of saponification (e.g., neutralization) of the one or more fatty acids. The degree of saponification (e.g., neutralization) may be within a range of from about 10 mol % to about 90 mol %, such as, for example within a range of from about 10 mol % to about 50 mol %, from about 10 mol % to about 80 mol %, from about 20 mol % to about 40 mol %, from about 20 mol % to about 90 mol %, from about 30 mol % to about 60 mol %, from about 40 mol % to about 80 mol %, from about 60 mol % to about 80 mol %, from about 65 mol % to about 85 mol %, from about 70 mol % to about 85 mol %, or from about 70 mol % to about 80 mol % based on a total molar amount of fatty acids. The degree of saponification is preferably within a range of form about 10 mol % to about 80 mol %, and more preferably within a range of from about 60 mol % to about 80 mol %. The at least one base and the fatty acid mixture may be maintained at a temperature within a range of from about 70 °C to about 90 °C throughout saponification. The at least one base and the fatty acid mixture are preferably agitated (e.g., stirred, mixed, continuously agitated, periodically agitated) throughout the duration of saponification. Once saponification (e.g., at least partial saponification) is complete, the resulting composition may be cooled to about room temperature to form cleansing compositions according to the disclosure. In some embodiments, the resulting compositions may be diluted with water before, during, or after cooling to form the cleansing compositions according to the disclosure.

The methods of forming cleansing compositions according to the disclosure may further include incorporating one or more additional cosmetically acceptable ingredients (e.g., additional surfactants, fragrances, colorants, pH adjustors, preservatives, etc.) at any stage during formation of the cleansing compositions. In some embodiments, additional surfactants may be introduced into the fatty acid mixture prior to neutralization. The cleansing compositions are preferably formed to be in the form of a liquid or a gel.

The following examples serve to illustrate the invention, and are not intended to, nor should they be construed to, limit the scope of the invention or be exhaustive or exclusive as to the scope of this disclosure. Indeed, various modifications of the invention and many further embodiments thereof, in addition to those shown and described herein, will become apparent to those skilled in the art from the full contents of this document, including the examples which follow and the references to the scientific and patent literature cited herein. The following examples contain important additional information, exemplification and guidance, which can be adapted to the practice of this invention in its various embodiments and the equivalents thereof.

### Example 1

### Sample Formulation

Various embodiments according to the present disclosure including the ingredients listed in Tables 1 and 2 of Examples 3 and 4 were prepared by combining the ingredients in the amounts listed to form exemplary samples S1-S5 (e.g., exemplary compositions) and comparative samples C1-C4 (e.g., comparative compositions). Fatty acids, glycerin, glycol distearate, and fatty alcohols, when present, were combined and heated to a temperature of about 80 °C until substantially all the fatty acids melted. A solution including water and sodium methyl/cocoyl taurate was heated to a temperature of about 50 °C and combined with the melted fatty acid mixture. It is noted that sodium methyl/cocoyl taurate is an optional additional surfactant of the cleansing compositions disclosed herein and may be omitted without materially affecting the cleansing composition. A caustic neutralizing solution including water, tetrasodium ethylenediaminetetraacetate (EDTA), and a base solution containing 45 wt % of potassium hydroxide and 55 wt % of water was combined with the melted fatty acid mixture and additional surfactant to neutralize at least a portion of the fatty acids. The resulting mixture was maintained at a temperature of about 80 °C until saponification was complete. Phenoxyethanol, caprylyl glycol/phenoxyethanol/hexylene glycol, and sodium benzoate, when present, were combined with the resulting composition and mixed at 40 °C for a sufficient amount of time to form a substantially homogeneous mixture. Subsequently, the mixture (e.g., the sample, the cleansing composition) was cooled to about room temperature (e.g., within a range of from about 20 °C to about 25 °C).

Each of the ingredients is commercially available and may be purchased from commercial sources including, but not limited to, Oleon (Ertvelde, BE), Alzo International Inc. (Sayreville, NJ), Vantage Specialty Chemicals, Inc. (Chicago, IL), BASF (Ludwigshafen, DE), Barnet Products Corp. (Englewood Cliffs, NJ), Independent Chemical Corp. (Glendale, NY), Ashland Specialty Ingredients (Wilmington, DE), Jeen International Corp. (Fairfield, NJ), the Merck Group (e.g., Merck K GaA) (Darmstadt, DE), and Sasol Chemicals LLC (Houston, TX).

### Example 2

### Physical Stability Assessment

Each of the exemplary and comparative compositions were stored at a temperature of about 50 °C for about 24 hours. Physical stability of the samples was visually assessed immediately after removing the samples from storage at about 50 °C. Stable compositions exhibited no substantial phase separation after about 24 hours. Unstable compositions exhibited at least some substantial phase separation after about 24 hours.

### Example 3

### Stability Analysis

TABLE 1
Compositions of C1-C4 and S1-S3 (wt %) and Corresponding Stability

| Ingredient | C1 | C2 | C3 | C4 | S1 | S2 | S3 |
|---|---|---|---|---|---|---|---|
| Behenic acid | 2.5 | 0 | 0 | 2.5 | 0 | 2.5 | 0 |
| Myristic acid | 18 | 0 | 10 | 12 | 10 | 18 | 0 |
| Lauric acid | 4 | 4 | 4 | 4 | 4 | 4 | 4 |
| Stearic acid | 0 | 10 | 8 | 0 | 8 | 0 | 10 |
| Palmitic acid | 0 | 9 | 0 | 0 | 0 | 0 | 9 |
| Glycerin | 10 | 20 | 10 | 10 | 10 | 10 | 20 |
| Glycol distearate | 0 | 0 | 0 | 0 | 0 | 0.6 | 0 |
| Cetearyl alcohol | 0 | 0 | 1 | 2 | 3 | 4 | 4 |
| Water/sodium methyl | 17 | 20 | 19 | 17 | 17 | 17 | 20 |
| cocoyl taurate | | | | | | | |
| Water | 38.4 | 26.7 | 39.9 | 45 | 39.9 | 34.5 | 24.7 |
| Tetrasodium EDTA | 0.1 | 0 | 0.1 | 0.1 | 0.1 | 0.1 | 0 |
| Potassium hydroxide | 8.9 | 7.3 | 6.9 | 6.3 | 6.9 | 8.2 | 7.3 |
| solution (45 wt % | | | | | | | |
| KOH, 55 wt % | | | | | | | |
| water) | | | | | | | |
| Phenoxyethanol | 0.5 | 0.5 | 0.5 | 0.5 | 0.5 | 0.5 | 0.5 |
| Caprylyl glycol/ | 0.6 | 0 | 0.6 | 0.6 | 0.6 | 0.6 | 0 |
| phenoxyethanol/ | | | | | | | |
| hexylene glycol | | | | | | | |
| Sodium benzoate | 0 | 0.5 | 0 | 0 | 0 | 0 | 0.5 |
| Stability | Unstable | Unstable | Unstable | Unstable | Stable | Stable | Stable |
| pH | 8.66 | 8.67 | 8.18 | 8.08 | 8 | 8.09 | 8.35 |

Comparative samples C1 and C2 were substantially free of fatty alcohols (e.g., cetearyl alcohol). Comparative samples C3 and C4 included cetearyl alcohol at about 1 wt % and about 2 wt %, respectively. Exemplary samples S1, S2, and S3 included cetearyl alcohol at about 3 wt %, about 4 wt %, and about 4 wt %, respectively. As shown in Table 1, comparative samples C1-C4 including less than about 3 wt % of fatty alcohols each exhibited at least some substantial phase separation after being held at about 50 °C for about 24 hours. Exemplary samples S1-S3 including at least about 3 wt % of one or more fatty alcohols (e.g., cetearyl alcohol) unexpectedly and advantageously exhibited no substantial phase separation after being held at about 50 °C for about 24 hours.

In particular, comparative sample C2 and exemplary sample S3 were substantially similar, with the exception of an amount of cetearyl alcohol included in each sample. Exemplary sample S3 included about 4 wt % of cetearyl alcohol and comparative sample C2 was substantially free of cetearyl alcohol. As shown in Table 1, comparative sample C2 exhibited at least some substantial phase separation after being held at about 50 °C for about 24 hours, while exemplary sample S3 exhibited no substantial phase separation. The improved stability of S3 in comparison to C2 is attributed to the presence of the fatty alcohol (e.g., cetearyl alcohol) at an amount of at least about 3 wt %.

### Example 4

### Fatty Alcohol Analysis

TABLE 2
Compositions of S2, S4, and S5 and Corresponding Stability

| Ingredient | S2 | S4 | S5 |
|---|---|---|---|
| Behenic acid | 2.5 | 2.5 | 2.5 |
| Myristic acid | 18 | 18 | 18 |
| Lauric acid | 4 | 4 | 4 |
| Glycerin | 10 | 10 | 10 |
| Glycol distearate | 0.6 | 0.6 | 0.6 |
| Cetearyl alcohol | 4 | 0 | 0 |
| Cetyl alcohol | 0 | 4 | 0 |
| Stearyl alcohol | 0 | 0 | 4 |
| Water/sodium methyl cocoyl taurate | 17 | 17 | 17 |
| Water | 34.5 | 34.5 | 34.5 |
| Tetrasodium EDTA | 0.1 | 0.1 | 0.1 |
| Potassium hydroxide solution | 8.2 | 8.2 | 8.2 |
| (45 wt % KOH, 55 wt % water) | | | |
| Phenoxyethanol | 0.5 | 0.5 | 0.5 |
| Caprylyl glycol/ | 0.6 | 0.6 | 0.6 |
| phenoxyethanol/hexylene glycol | | | |
| Stability | Stable | Stable | Stable |
| pH | 8.09 | 8.27 | 8.15 |

Exemplary samples S2, S4, and S5 were each substantially similar, with the exception of the fatty alcohol included in each. Exemplary sample S2 included about 4 wt % of cetearyl alcohol, exemplary sample S4 included about 4 wt % of cetyl alcohol, and exemplary sample S5 included about 4 wt % of stearyl alcohol. As shown in Table 2, each of exemplary samples S2, S4, and S5 advantageously exhibited no substantial phase separation after being held at about 50 °C for about 24 hours.

Additional non-limiting examples of embodiments of the disclosure are set forth below.

Embodiment 1: A cleansing composition comprises a fatty acid soap material, at least one fatty alcohol in an amount at least about 3% by weight (wt %) based on a total weight of the cleansing composition, wherein the at least one fatty alcohol is selected from the group consisting of cetyl alcohol, stearyl alcohol, cetearyl alcohol, and mixtures thereof, and water.

Embodiment 2: The cleansing composition of Embodiment 1, wherein the at least one fatty alcohol comprises cetearyl alcohol.

Embodiment 3: The cleansing composition of Embodiment 2, wherein the cetearyl alcohol comprises cetyl alcohol and stearyl alcohol in a molar ratio of about 1:1.

Embodiment 4: The cleansing composition of any one of Embodiments 1-3, comprising the at least one fatty alcohol in an amount within a range of from about 3 wt % to about 15 wt % based on the total weight of the cleansing composition.

Embodiment 5: The cleansing composition of any one of Embodiments 1-4, wherein the fatty acid soap material comprises at least one fatty acid soap and at least one free fatty acid.

Embodiment 6: The cleansing composition of any one of Embodiments 1-5, wherein the fatty acid soap material comprises at least one fatty acid soap in an amount within a range of from about 10 mol % to about 80 mol % based on a total amount of the fatty acid soap material.

Embodiment 7: The cleansing composition of any one of Embodiments 1-6, wherein the cleansing composition exhibits no substantial phase separation after being heated to and held at a temperature of about 50 °C for about 24 hours.

Embodiment 8: The cleansing composition of any one of Embodiments 1-7, wherein the cleansing composition is substantially homogeneous.

Embodiment 9: The cleansing composition of any one of Embodiments 1-8, further comprising one or more surfactants other than the fatty acid soap material.

Embodiment 10: The cleansing composition of any one of Embodiments 1-9, wherein the cleansing composition is substantially free of PEG.

Embodiment 11: The cleansing composition of any one of Embodiments 1-10, wherein the cleansing composition is substantially free of sulfates.

Embodiment 12: The cleansing composition of any one of Embodiments 1-11, comprising the water in an amount within a range of from about 20 wt % to about 90 wt % based on the total weight of the cleansing composition.

Embodiment 13: The cleansing composition of any one of Embodiments 1-12, wherein the cleansing composition is in a form of a liquid or a gel.

Embodiment 14: A method of forming a cleansing composition comprises combining one or more fatty acids to form a fatty acid mixture, melting the fatty acid mixture, incorporating at least one fatty alcohol into the fatty acid mixture at an amount of at least about 3 wt % based on a total weight of the cleansing composition, and neutralizing at least a portion of the one or more fatty acids by reacting the one or more fatty acids with at least one base to form at least one fatty acid soap. The at least one fatty alcohol is selected from the group consisting of cetyl alcohol, stearyl alcohol, cetearyl alcohol, and mixtures thereof.

Embodiment 15: The method of Embodiment 14, wherein incorporating the at least one fatty alcohol comprises incorporating the at least one fatty alcohol into the fatty acid mixture before, during, or after melting the fatty acid mixture.

Embodiment 16: The method of Embodiment 14 or Embodiment 15, wherein the at least one base is in the form of a caustic neutralizing solution comprising water and the at least one base.

Embodiment 17: The method of any one of Embodiments 14-16, wherein the at least one base comprises potassium hydroxide.

Embodiment 18: The method of any one of Embodiments 14-17, wherein neutralizing at least a portion of the one or more fatty acids comprises providing an amount of the at least one base sufficient to neutralize an amount of the one or more fatty acids within a range of from about 10 mol % to about 80 mol % based on an initial amount of the one or more fatty acids.

Embodiment 19: The method of any one of Embodiments 14-18, wherein incorporating the at least one fatty alcohol comprises incorporating an amount of the at least one fatty alcohol within a range of from about 3 wt % to about 5 wt % based on the total weight of the cleansing composition.

Embodiment 20: The method of any one of Embodiments 14-19, wherein the one or more fatty acids are selected from the group consisting of behenic acid, myristic acid, lauric acid, stearic acid, palmitic acid, and mixtures thereof.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleansing composition, comprising:
a fatty acid soap material;
at least one fatty alcohol in an amount of at least about 3% by weight (wt %) based on a total weight of the cleansing composition, wherein the at least one fatty alcohol is selected from the group consisting of cetyl alcohol, stearyl alcohol, cetearyl alcohol, and mixtures thereof; and
water.

2. The cleansing composition of claim 1, wherein the at least one fatty alcohol comprises cetearyl alcohol.

3. The cleansing composition of claim 2, wherein the cetearyl alcohol comprises cetyl alcohol and stearyl alcohol in a molar ratio of about 1:1.

4. The cleansing composition of claim 1, comprising the at least one fatty alcohol in an amount within a range of from about 3 wt % to about 15 wt % based on the total weight of the cleansing composition.

5. The cleansing composition of claim 1, wherein the fatty acid soap material comprises at least one fatty acid soap and at least one free fatty acid.

6. The cleansing composition of claim 5, wherein the fatty acid soap material comprises the at least one fatty acid soap in an amount within a range of from about 10% by mole (mol %) to about 80 mol % based on a total amount of the fatty acid soap material.

7. The cleansing composition of claim 1, wherein the cleansing composition exhibits no substantial phase separation after being heated to and held at a temperature of about 50 °C for about 24 hours.

8. The cleansing composition of claim 1, wherein the cleansing composition is substantially homogeneous.

9. The cleansing composition of claim 1, further comprising one or more surfactants other than the fatty acid soap material.

10. The cleansing composition of claim 1, wherein the cleansing composition is substantially free of PEG.

11. The cleansing composition of claim 1, wherein the cleansing composition is substantially free of sulfates.

12. The cleansing composition of claim 1, comprising the water in an amount within a range of from about 20 wt % to about 90 wt % based on the total weight of the cleansing composition.

13. The cleansing composition of claim 1, wherein the cleansing composition is in a form of a liquid or a gel.

14. A method of forming a cleansing composition, the method comprising:
combining one or more fatty acids to form a fatty acid mixture;
melting the fatty acid mixture;
incorporating at least one fatty alcohol into the fatty acid mixture at an amount of at least about 3 wt % based on a total weight of the cleansing composition, wherein the at least one fatty alcohol is selected from the group consisting of cetyl alcohol, stearyl alcohol, cetearyl alcohol, and mixtures thereof; and
neutralizing at least a portion of the one or more fatty acids by reacting the one or more fatty acids with at least one base to form at least one fatty acid soap.

15. The method of claim 14, wherein incorporating the at least one fatty alcohol comprises incorporating the at least one fatty alcohol into the fatty acid mixture before, during, or after melting the fatty acid mixture.

16. The method of claim 14, wherein the at least one base is in the form of a caustic neutralizing solution comprising water and the at least one base.

17. The method of claim 14, wherein the at least one base comprises potassium hydroxide.

18. The method of claim 14, wherein neutralizing at least a portion of the one or more fatty acids comprises providing an amount of the at least one base sufficient to neutralize an amount of the one or more fatty acids within a range of from about 10% by mole (mol %) to about 80 mol % based on an initial amount of the one or more fatty acids.

19. The method of claim 14, wherein incorporating the at least one fatty alcohol comprises incorporating an amount of the at least one fatty alcohol within a range of from about 3 wt % to about 5 wt % based on the total weight of the cleansing composition.

20. The method of claim 14, wherein the one or more fatty acids are selected from the group consisting of behenic acid, myristic acid, lauric acid, stearic acid, palmitic acid, and mixtures thereof.
